(19) United States
(12) Patent Application Publication
(10) Pub. No.: US 2013/0262584 A1
(43) Pub. Date: Oct. 3, 2013

(54) System and Method for Displaying Information About Pairs of Matched Users

(71) Applicant: ZOOSK, INC., A DELAWARE CORPORATION, San Francisco, CA (US)

(72) Inventors: Shayan G. Zadeh, San Francisco, CA (US); Alexander F. Mehr, San Francisco, CA (US); Eric R. Barnett, Menlo Park, CA (US); Charles E. Gotlieb, San Francisco, CA (US)

(21) Appl. No.: 13/854,044

(22) Filed: Mar. 29, 2013

Related U.S. Application Data
(60) Provisional application No. 61/617,050, filed on Mar. 29, 2012.

(51) Int. Cl. H04L 29/08

(52) U.S. Cl. CPC H04L 67/306
USPC 709/204

(57) ABSTRACT

A system and method allows two users to utilize a shared profile of information about the two users and their relationship with one another. Information from the couples profile and its operation may be used to search or match users of a coupled profile with other users after the relationship between the two users of the couples profile has been indicated to have ended.

### RELATED APPLICATIONS

This application claims the benefit of attorney docket number 1728, U.S. Provisional Application 61/617,050 entitled, “Method and Apparatus for Displaying Information About Pairs of Matched Users and Assisting Users in Matching Themselves, filed on Mar. 29, 2012 by Shayan Zedeh, Alex Mehr, Eric Barnett and Charles Gotlieb, and is related to the subject matter of attorney docket number 1763, U.S. patent application Ser. No. AA/AAA,AAA entitled, “System and Method for Identifying Other Users After a Termination of a Relationship” filed on Mar. 29, 2013 by Alex Mehr, Shayan Zedeh, Eric Barnett and Charles Gotlieb and U.S. patent application Ser. No. 13/200,229 entitled, “System and Method for Selecting Compatible Users for Activities Based on Experiences, Interests or Preferences” filed on Sep. 21, 2011 by Shayan G. Zedeh and Alexander F. Mehr, each having the same assignee as this application and each is incorporated herein by reference in its entirety.

### FIELD OF THE INVENTION

The present invention is related to computer software and more specifically to computer software for matching users of a web site and displaying information about matched users.

### BACKGROUND OF THE INVENTION

It can be desirable for a web site to provide additional services to its users. It can also be desirable to utilize information so that the services provided are provided in the optimal manner. What is needed is a system and method that provides additional services to users of a web site and uses the information it receives from the additional services and other services it provides to provide information in an optimal manner.

### SUMMARY OF INVENTION

A system and method allows users of a website to provide registration information, such as characteristics about themselves, and preferences of other users with whom they would prefer to enter a relationship. The system and method introduces and connects pairs of users, such as by using conventional dating website techniques or other similar techniques, or already-matched pairs of users may register.

When two users have entered into a relationship, such as an exclusive relationship with each other, one of the two users may request to build a couples profile, containing information about, and experiences of, the couple consisting of two users, and such request is received from one of the two users with an identifier of the other user in the couple. If such other user indicates permission to build the couples profile, the couples profile is associated with the two users and the date and the time of receipt of permission, or receipt of the request. In one embodiment, the system and method may request and receive from one or both of the users of the couple social network information, such as user identifiers on a social network, automatic posting options that allow posts from one or both of the couple made to the couples profile to be automatically (without further user input) uploaded to the user's account on the social network, and posting permissions regarding whether friends of a user can post or comment on the couples profile.

Once a couples profile has been built as described above, either of the two users of the couple corresponding to the profile can provide postings, an indication that the relationship between the couple has been broken up, or an indication that a broken up relationship has been resumed, and such information is received. If an indication is received that the relationship between the couple is broken up, the couples profile is “locked”, disallowing viewing and posting, though the users corresponding to the couple of the profile can still access the profile to retrieve information from the profile. In one embodiment, each member of the couple is requested to indicate which member of the couple initiated the breaking up of the relationship, and such information is received. If a member of the couple indicates that a broken up relationship is resumed, the couples profile is unlocked to allow viewing and posting, though in one embodiment, the other member of the couple must again provide permission in a manner similar to that described above.

If one of the members of the couple provides a posting, such posting is received and stored associated with the profile for the user that is currently in the couple (i.e. not broken up), and if either or both of the users corresponding to the couple have indicated that such postings should be reposted to their social network accounts, such reposting is performed. In one embodiment, a manual request may be received from either of the two users for which automatic posting is not enabled for such a posting, to allow individual posts to a couples profile to be manually (e.g. by the system and method, but upon direction of the user) reposted to that user's social network account. When information is posted to a user's social network account, a link to the couples profile may also be posted to the user's social network account to allow people viewing information on such social network account to access the couples profile for viewing, and optionally posting as described herein. Additionally, a link to the couples profile may be made available to the users, to allow them to send such a link to their profile using other manners such as e-mail, or other communication techniques.

At any time, any user or nonuser of the website that displays the couples profile may request to view the couples profile, e.g. by using the link, and such request is received. In response to the request, the couples profile is displayed. In one embodiment, the couples profile includes a display of a number of approvals of the couple received from other such individuals, and a display of posts and comments to such posts, received from the users corresponding to the couple, and optionally friends of such users. Viewers of the profile may indicate approval of the couple, or approval of individual postings or comments on the couples profile, and the number of such approvals is stored and may be displayed with the couples profile, such as by displaying approvals of a posting next to the posting, and displaying approvals of the couple at the top of the profile. Additionally, if the users have enabled posting or commenting by friends, e.g. of the user's social network account, if the viewer of the couples profile is such a friend, the viewer may provide posts, or comments to existing posts, and such posts or comments are received, stored associated with the couples profile, and displayed to viewers of the couples profile. Users may also enable receiving messages from friends, and such friends may provide messages (e-mail or chat) to individual members of the couple via user interface elements displayed on the couples profile. In one embodiment, both users (or one user in one embodiment) may set permissions to make the couples profile only visible to their friends, and if such permissions have been set, the couples profile will only be available to users of the social network identified as friends of either of the users on that social network, and to the couple themselves. Permissions described herein may be specified differently for different circles of friends.

The system and method records information and activities of the users of the website that includes the couples profile, and uses such activities to order search results of users, and to identify proposed matches of users on the website. Information of the users includes the characteristics about the user received from that user, and preferences of such characteristics and optionally other characteristics that the user has identified for other users. Information about a user additionally includes information about other users with which the user has built a couples profile, the amount of time between the time that a couples profile is built and an indication of a breakup of such couple is received, whether the user broke off the relationship, as confirmed by both users in the relationship and preference information received from a user following resumption of activities on the website after an indication of a breakup is received. Activities of users that are recorded include whether a user clicked on a summary profile of an other user when viewing search results, in order to view a complete profile of the other user, whether the user sent a message to the other user after viewing the user's profile, and whether the user received a response to such message from the other user.

The sort order of other users that match a search results of the user, and whether an other user is matched to a user, may be a function of several scores that are identified using the information described above. One such score may include a preference score, that identifies how well the characteristics identified of one user matches the preferences identified by another user. Another score may be a compatibility score, which identifies how closely the characteristics of one user's partner in a couple for which a profile was built, match another user. These two scores may be identified in a single direction from the user performing the search or for the user for whom the match is being identified, or the scores may be identified in both directions, from the user as identified above, and to the user from the other user who is the subject of the search or potential match.

In one embodiment, if the two users in a relationship that is broken off both indicate the same user broke off the relationship, when using the compatibility score for a search or match, such score may be weighted higher for the user who did not break off the relationship, and lower for the other user. In one embodiment, characteristics corresponding to preference information that is changed after a breakup that are received from a user may be weighted higher than other characteristics, such as where a characteristic of the user's partner in the relationship matched the preference for that characteristic before the change, but does not meet the preference for that characteristic after the change.

Another score used for ordering search results or for matching users may be a popularity score, which may be a function of the percentage of times that a user's summary profile is clicked on, the percentage of times that a user who views a full profile of another user sends a message to that user, and the percentage of times that a user who sends a message receives a response. Another score may be a relationship suitability score, which is higher for users who have more long-term relationships, and lower for users who have many short-term relationships, as indicated by the length of time between the dates a couples profile is built or requested, and an indication of a breakup of the relationship is received.

### BRIEF DESCRIPTION OF THE DRAWINGS

FIG. 1 is a block schematic diagram of a conventional computer system.

FIG. 2A is a flowchart illustrating a method of building a couples profile according to one embodiment of the present invention.

FIG. 2B is a flowchart illustrating a method of providing information about a couple using a couples profile according to one embodiment of the present invention.

FIG. 2C is a flowchart illustrating a method of providing and receiving information to allow users and non users to view and interact with a couples profile according to one embodiment of the present invention.

FIG. 3A is a flowchart illustrating a method of providing results of a search for users using information received from one or more couples profiles according to one embodiment of the present invention.

FIG. 3B is a flowchart illustrating a method of matching users using information received from one or more couples profiles according to one embodiment of the present invention.

FIG. 4 is a block schematic diagram of a system for building couples profiles, receiving information about couples profiles, providing and receiving information to allow users and non users to view and interact with a couples profile, providing search results using information from a couples profile and matching users using information provided using a couples profile, according to one embodiment of the present invention.

### DETAILED DESCRIPTION OF A PREFERRED EMBODIMENT

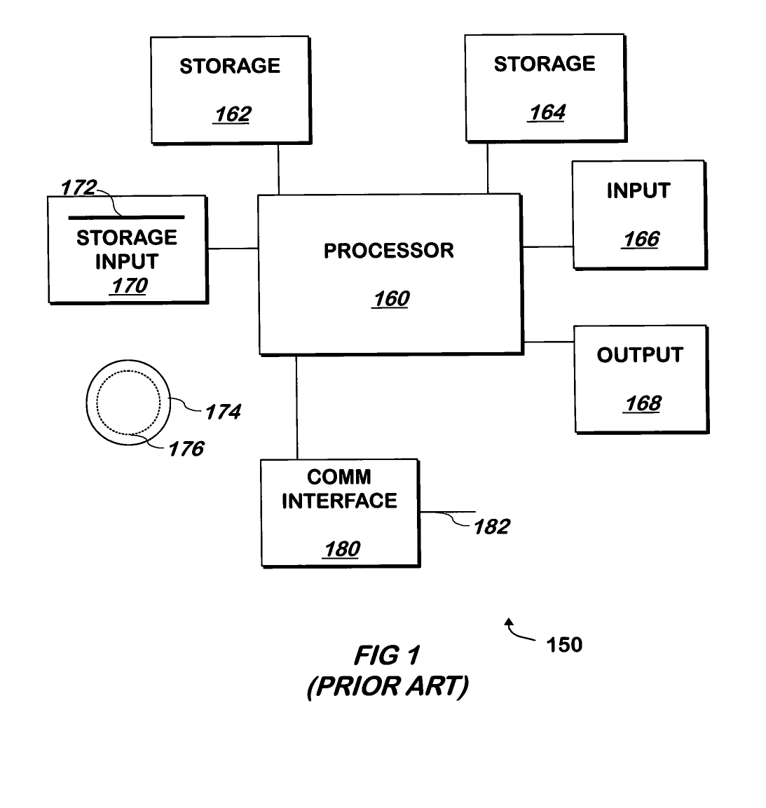

The present invention may be implemented as computer software on a conventional computer system, methods, or processors operating on a computer system. Referring now to FIG. 1, a conventional computer system 150 for practicing the present invention is shown. Processor 160 under control of an operating system (not shown) retrieves and executes software instructions stored in storage 162 such as memory, which may be Random Access Memory (RAM) and may control other components to perform the present invention. Storage 162 may be used to store program instructions or data or both. Storage 164, such as a computer disk drive or other nonvolatile storage, may provide storage of data or program instructions. In one embodiment, storage 164 provides longer term storage of instructions and data, with storage 162 providing storage for data or instructions that may only be required for a shorter time than that of storage 164. In one embodiment, all elements designated herein as storage may include conventional memory or disk storage and may include a conventional database. Input device 166 such as a computer keyboard or mouse or both allows user input to the system 150. Output 168, such as a display or printer, allows the system to provide information such as instructions, data or other information to the user of the system 150. Storage input device 170 such as a conventional floppy disk drive or CD-ROM drive accepts via input 172 computer program products 174 such as a conventional floppy disk or CD-ROM or other nonvolatile storage media that may be used to transport computer instructions or data to the system 150. Computer program product 174 has encoded thereon computer readable program code devices 176, such as magnetic charges in the case of a floppy disk or optical encodings in the case of a CD-ROM which are encoded as program instructions, data or both to configure the computer system 150 to operate as described below.

In one embodiment, each computer system 150 is a conventional SUN MICROSYSTEMS T SERIES SERVER running the SOLARIS operating system commercially available from ORACLE CORPORATION of Redwood Shores, Calif., a PENTIUM-compatible personal computer system such as are available from DELL COMPUTER CORPORATION of Round Rock, Tex. running a version of the WINDOWS operating system (such as XP, VISTA, or 7) commercially available from MICROSOFT Corporation of Redmond Wash. or a Macintosh computer system running the MACOS or OPENSTEP operating system commercially available from APPLE INCORPORATED of Cupertino, Calif. and the FIREFOX browser commercially available from MOZILLA FOUNDATION of Mountain View, Calif. or INTERNET EXPLORER browser commercially available from MICROSOFT above, although other systems may be used. Each computer system 150 may be a DROID 2 mobile telephone commercially available from MOTOROLA CORPORATION of Schaumberg, Ill. running the ANDROID operating system commercially available from GOOGLE, INC. of Mountain View, Calif. Various computer systems may be employed, with the various computer systems communicating with one another via the Internet, a conventional cellular telephone network, an Ethernet network, or all of these.

Receive/Provide/Store Registration Information/Login of Each User.

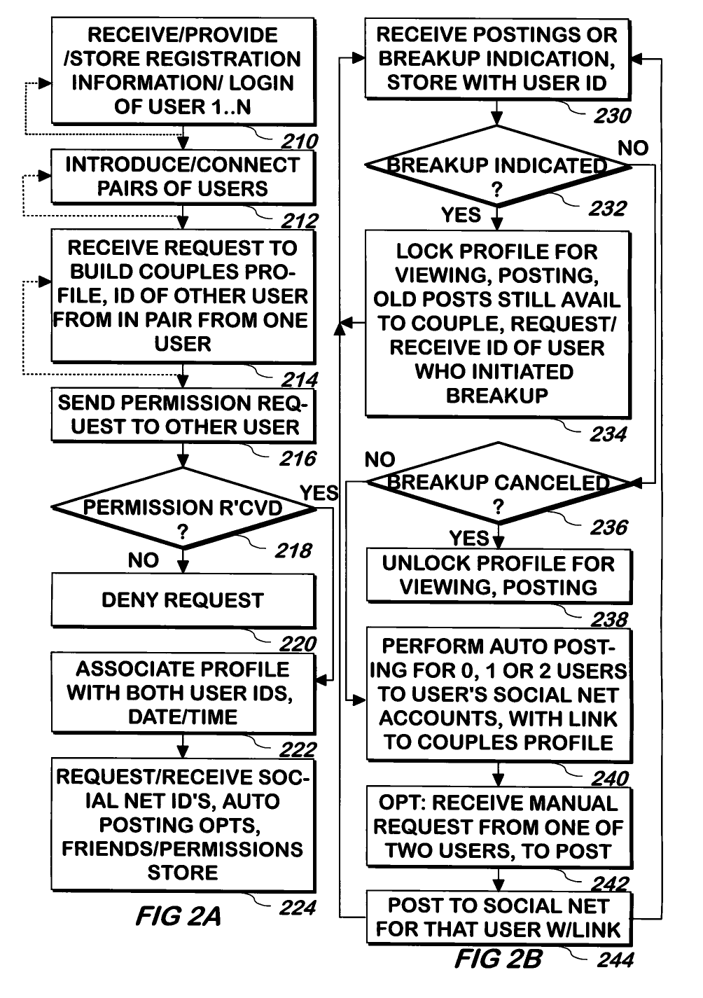

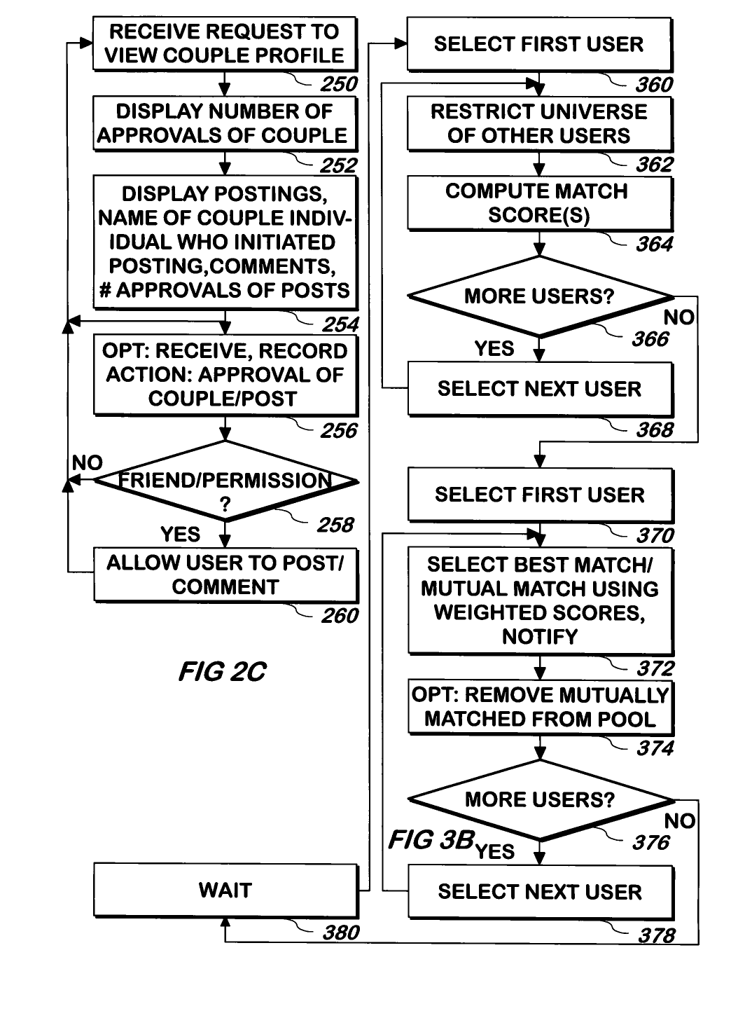

FIG. 2A is a flowchart illustrating a method of building couples profiles according to one embodiment of the present invention. Referring to FIG. 2A, registration information and/or log in information provided by any number of users of a primary website or mobile application, such as a dating website or application, is received and stored 210. In one embodiment, registration information from a user may include a user identifier and corresponding password which may be subsequently provided by the same user as part of log in information.

Registration information received from a user may also include any profile information and/or preference information. Profile information includes any information corresponding to or describing the user, and it may include basic information, such as the user's age, gender, height and weight, religions, body type, etc., as well as other information about the user, such as interests, activities, taste in music, movies, books, and/or sports, etc. Profile information may be received as text via fields provided on a web page, or as files, such as digital photos uploaded from the user's computer via an uploading tool, or any other type of information received in any other manner.

Preference information received from a user may include any characteristics that the user prefers in a person to date or otherwise interact with, including desired physical characteristics, as well as desired interests, etc., and any other desired characteristics of a person that the user would most like to meet, communicate with, date, or interact.

In one embodiment, profile and preference information may be received from a user during an initial registration period, or updated profile and/or preference information may be received from the user through multiple registration periods, or updated profile and/or preference information may also be received from the user at any time as the user's characteristics or preferences change. Any changed or updated profile and/or preference information received may be recorded with the date and time of when such update is received. Registration information, including profile information and preference information or updated profile information or updated preference information, and/or log in information may be received from any number of users and stored at any time, and the process of receiving and storing registration and/or log in information may be an independently operating process, as shown by the dashed lines in the Figure.

Introduce/Connect Pairs of Users.

Pairs of users, such as potentially matched users and/or couples, are introduced and/or connected 212, such as via a conventional dating website which may include email notifications as described below. Any number of users may be introduced or connected to any number of other users at any time, and the process of connecting pairs of users may be an independently operating process as shown by the dashed lines in the Figure. Users who are already matched may register and not utilize this step.

Receive Request to Build Couples Profile and Identifier of Other User in Pair from One User.

In one embodiment, when a couple wishes to announce their relationship (e.g. a romantic relationship as might result from dating), they may build a couples profile containing content about the couple, including photos, text, and links. At any time, a request may be received from a first user to build a couples profile along with a user identifier corresponding to a second user to associate with the requested couples profile 214. In one embodiment, an individual profile is a profile page associated with one user of the primary website, and a couples profile is a similar page that is associated with more than one user. Both users associated with a couples profile may provide couples profile information or updated couples profile information, and both users may post to, comment to, and/or otherwise maintain the couples profile in a manner similar to the manner in which individual users each post to and maintain their own individual profiles on conventional social network websites.

Send Permission Request to Other User.

The second user corresponding to the user identifier received with the request to build the couples profile is identified and a request for permission to build the couples profile is sent 216 to such second user. In one embodiment, the request for permission may be sent as a notification using conventional notification techniques, and such request for permission may include the user identifier of the first user requesting to build the couples profile.

If Permission Not Received.

Deny Request.

If permission to build the couples profile is not received from the second user 218, then the first user's request to build the couples profile is denied and no couples profile is built and/or displayed 220.

If Permission Received.

Associate Profile with Both User Identifiers and Date/Time.

If permission to build the couples profile is received from the second user 218, then a couples profile is created as requested and the couples profile is associated with the user identifiers of both the first user and the second user, as well as the date and time of when the couples profile is created, which may be the date and time of the original request or the date and time permission from the other user was received 222.

A link to the couples profile may be provided to the user requesting the couples profile, for example containing as REST information (the information to the right of a slash to the right of the top level domain name in a URL), an identifier of the profile, so that the couples profile may be shared with other users and non users of the web site. Such link may be made available to the users whenever they log in at a subsequent iteration of step 210 using conventional log in techniques.

Request/Receive/Store Social Network Identifiers with Auto-Posting Options, Import Social Network Friends with Friend Posting/Messaging/Viewing Permissions.

One or more social network account identifiers and permissions to post to such account corresponding to one or more social networks, e.g. FACEBOOK, is requested and may be received from both the first user and the second user, along with any auto-posting options, and any such received social network account identifiers and/or auto-posting options are stored 224.

In one embodiment, auto-posting options received from a first user may be received as one of any number of options. In one option, any posts to the couples profile made by the first user or made by the second user may be automatically posted to the first user's social network account. In a second option, only posts to the couples profile made by the first user may be automatically posted to the first user's social network account. Posts made by the second user to the couples profile may require manual permission from the first user to be posted to the first user's social network account. In a third option, no posts made to the couples profile by first user or by the second user may be automatically posted to the first user's social network account, and permission to post to the first user's social network account may be manually required from the first user each time the first user (or the second user) posts to the couples profile. Any number of other auto-posting options may be received and stored for the first user, and any similar auto-posting options may be received and stored for the second user in a similar manner.

Additionally as part of step 224, the first user's social network (e.g. FACEBOOK) friends or the second user's social network friends, or both users social network friends may be imported from any social network, or permissions may be received from the respective users of the couples profile to access their friends lists at such social network accounts, and friend posting and messaging permissions may be received from the user importing the social network friends and stored. Friend posting and messaging permissions may include rules which determine the actions any imported social network friends are permitted or not permitted to make with respect to the first and second users' couples profile and to the couple themselves. In one embodiment, friend posting and messaging permissions may allow or not allow social network friends to post to the couples profile or to comment on posts to the couples profile or both, and to send messages to the user who has that person as a friend on the social network account or to both users, and different (or the same) friend posting and messaging permissions may be received for each social network friend or grouping of social network friends that are imported for either user associated with the couples profile.

In one embodiment, if permission to auto-post to the user's social network account is received from a user requesting to build a couples profile, then the user's relationship status information may be updated on the user's social network account to reflect the new couples profile (e.g. the user's relationship status may be updated to “in a relationship” on the user's FACEBOOK page).

In one embodiment, step 224 includes requesting and receiving social network viewing options that determine who can view the coupled profile. In one embodiment, if both users in the couple specify, or one user in the couple specifies, that the couples profile can only be viewed by social network friends of the users of the couple, then only such people can view the couples profile of that couple, as well as the couple themselves. It is noted that the couple has all permissions described herein.

Receive Postings or Breakup Indication, Store with User Identifier.

FIG. 2B is a flowchart illustrating a method for managing activity corresponding to a couples profile according to one embodiment of the present invention. Referring now to FIG. 2B, any number of actions, including postings or posts to a couples profile or breakup indications corresponding to a couples profile, are received and stored associated with the user identifier corresponding to the user from which each such action is received 230. In one embodiment, posting activity to the couples profile may include any text posts such as messages, photo posts, posted links, comments to other posts, and indications of approval such as a “thumbs up” post, or any other posts. The breakup indication may be received as “enabled” if the couple corresponding to a couples profile are not together, or the breakup indication may be received as “disabled” when the couple corresponding to a couples profile are together or back together after a previous breakup.

If Action Received is Breakup Indication Received.

Lock Profile for Viewing and Posting, Allowing Old Posts to be Still Available to Associated Users, and Request/Receive Identifier of User that Initiated Breakup.

If a user associated with a couples profile indicates that the couple corresponding to the couples profile is broken up or no longer together 232, then the user's couples profile is locked for viewing and posting 234. In one embodiment, the couples profile may be locked for viewing such that the profile and any existing posts and/or comments to posts to the profile are not available to be viewed by any users except the two users associated with such couples profile. The couples profile may be locked for posting such that no new posts or comments may be made to the couples profile by the two associated user or any other users, though existing posts may still be available for viewing by, and retrieval of the content by, the two users associated with the couples profile. In one embodiment, the indication that a couple corresponding to a couples profile is no longer together may be received from either user associated with such couples profile and stored at any time. In one embodiment, the user identifier corresponding to the user providing the breakup indication as enabled may be recorded with the breakup indication, or optionally, one or both users may be asked to identify the user initiating the breakup, and any response received from one or both users is recorded.

In one embodiment, a breakup indication corresponding to a couples profile that has been enabled may subsequently be disabled again, for example, if the couple corresponding to such profile reunites. If an indication is received corresponding to a couples profile to disable a breakup indication, or enable a reunification indication, that has been previously enabled, then permission from the second user corresponding to such couples profile may be requested and received prior to disabling the enabled breakup indication.

If Action is Received as Breakup Disabled.

Unlock Profile for Viewing and Posting.

If the action received from the user is not an indication to enable a breakup indication corresponding to the couples profile 232, then the method continues at step 236.

At step 236, if the action received from the user is an indication to disable the breakup indication, or enable a reunification indication, corresponding to a couples profile 236, such as if a breakup indication that has previously been enabled corresponding to a couples profile is now disabled, then such couples profile is unlocked for viewing and posting 238. In one embodiment, the couples profile including any posts and comments to posts made to the couples profile may be made available for viewing and posting according to the rules and permissions previously associated with the couples profile, or new rules and permissions for viewing and posting may be received. The method continues at step 230.

If Action Received is not Breakup Enabled or Reunification Enabled.

Perform Auto-Post for 0, 1, or 2 Users to User's Social Network Accounts, Including Link to Couples Profile.

At step 236, if the action received is not a reunification enabled indication, then the user provided posting information at step 230, in which case, any automatic posting options enabled to allow reposting to a social network specified by the user, such auto-posting(s) including a link to the couples profile, is performed for none, one, or both of the users associated with the couples profile according to the options set for each of the users corresponding to the couples profile 240. In one embodiment, using the social network identifier(s) and the automatic posting option(s) received from each user associated with the couples profile, the received post to the couples profile may be automatically posted to any social network accounts for which auto-posting permission has been received. Any automatic post to a user's social network account may include the received post to the couples profile, as well as a link to view the couples profile.

Optionally Receive Manual Request from One or Two Users to Post.

Optionally in one embodiment, if one or both of the two users associated with the couples profile has provided an indication not to allow automatic posting to his/her social network account, then permission may be manually requested and/or received from such user or users to post to his/her social network account 242. In one embodiment, such permission may be recorded when one of the couple views the profile, for example, via a button next to each post.

Post to Social Network for that User with Link.

Any such post to the couples profile is posted to the social network account corresponding to the user(s) from which permission was received manually, and the post to the social network account(s) may include a link back to the original post that was made to the couples profile 244.

Receive Request to View Couples Profile.

FIG. 2C is a flowchart illustrating a method for displaying couples profiles according to one embodiment of the present invention. Referring now to FIG. 2C, a request to view a couples profile is received 250. In one embodiment, the request to view the couples profile may be received from a user, such as a user of the primary website or a user of a social network website on which a post to the couples profile was re-posted, either automatically or manually, when the user clicks on a link to view the couples profile. The request to view the couples profile may be received from any other user or person, such as a person who receives a link to the couples profile.

Display Number of Approvals of Couple.

The number of approvals of the couple associated with the couples profile, such as the number of thumbs up indications received with respect to the couple and/or couples profile, is displayed to the user or other person requesting to view the couples profile 252.

Display Postings, Name of Couple Individual Who Initiated Postings, Comments, and Number of Approval of Posts.

Any posts that have been made to the couples profile are also displayed 254 to the user or other person requesting to view the couples profile, along with the name or identifier of the user that initiated each post, any comments made by other users corresponding to each post, and the number of approvals or thumbs up received corresponding to each displayed post.

Optionally Receive, Record Action: Approval of Couple and/or Post.

Optionally, an action may be received and recorded from the viewer of the couples profile, such as an indication of approval of the couple corresponding to the couple displayed in the couples profile and/or an indication of approval of any posts displayed on the couples profile, and any such received action is recorded 256.

If Friend with Posting Permission.

Allow User to Post and/or Comment and/or Message.

If the user requesting to view the couples profile is a friend of either or both users associated with the couples profile, such as via the primary website or via one or more social networks, and the friend posting and messaging permission(s) corresponding to the viewing user, previously received and stored as part of step 224, grant permission to the viewing user to post to the couples profile and/or comment on posts on the couples profile and/or send messages to one or both users of the couple 258, then any posts and/or comments to posts may be received from the viewing user, recorded, and displayed and messages may be sent, each in accordance with the permissions 260. To post to the couples profile, leave a comment on the couples profile or message the user, in one embodiment, the viewing user must be logged in to the primary website or logged into the user's social network as a friend that has been granted the posting and messaging permissions appropriate to the action being performed.

In the embodiment in which only friends of the users who make up the couple can view the couples profile if such permissions are set as described above, if the requested profile has permissions set as described above to only allow viewing by friends of the couple (or one of the users of the couple), to view the couples profile, the viewing user must be logged into the user's social network as a friend that has been granted such permission.

In one embodiment, to access a permitted function that is only permitted by friends, the viewing user may be provided with an opportunity to log in to their social network account, and if authenticated and a friend of at least one of the couple, such permission or permissions will be granted.

It is noted that, although one social network and one social network account per user is described herein, any number of social networks may be used with any number of social network accounts per user.

Use of Breakup Information to Sort Search Results.

Receive Search Parameters.

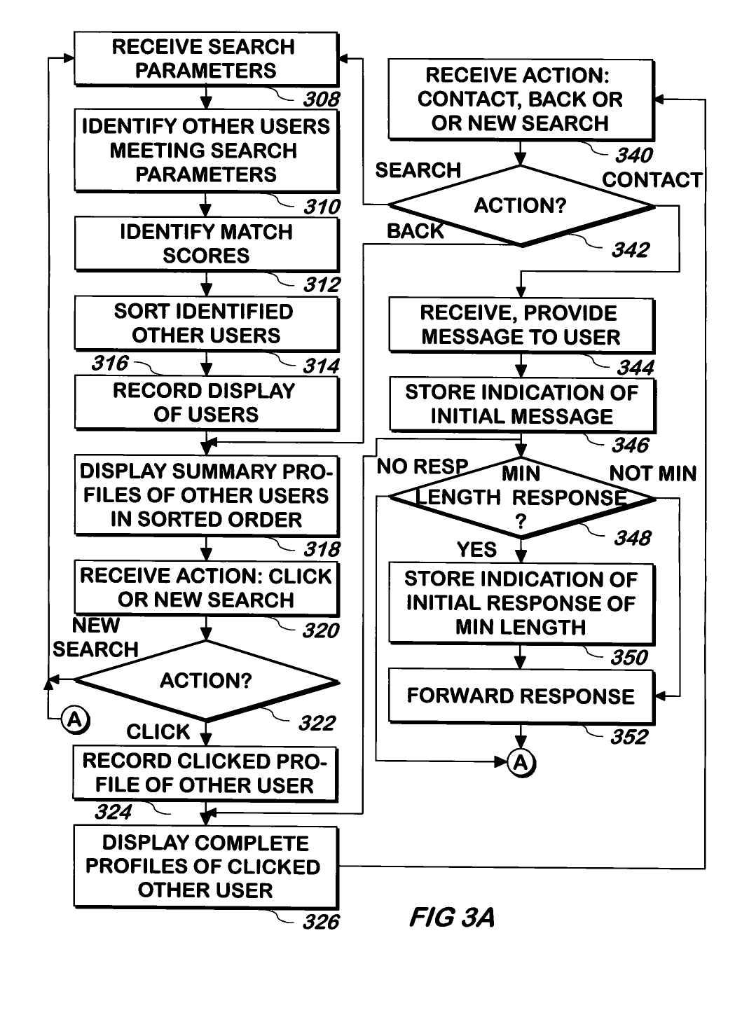

FIG. 3A is a flowchart illustrating a method of searching and sorting search results using information received about a user according to one embodiment of the present invention. Referring now to FIG. 3A, search parameters are received 308 from a selected user, such as a user of a dating website. In one embodiment, search parameters may be any parameters specifying a preference or preferred range for any number of characteristics, such as a preferred age or preferred age range, preferred gender, preferred height or height range, preferred location or location area, and/or any other preferences or preference ranges for any number of other of characteristics. Any user may perform a search for other users using search parameters at any time.

Identify Other Users Meeting Search Parameters.

Using the search parameters received from the selected user, other users fitting such parameters are identified 310 for the selected user. In one embodiment, profile and/or preference information corresponding to other users is compared to the received search parameters to identify the other users that meet the selected user's search parameters.

Identify Match Scores.

For each other user identified as meeting the selected user's search parameters, a match score is computed 312 with respect to the selected user. Components of the match score may include one or more preference scores, compatibility scores, popularity scores, relationship suitability scores, each described below, and any other scores. In one embodiment, such individual components of the match score may be weighted and summed together to determine the match score. Weights for each component of the match score may be determined or adjusted as described below.

A preference score may be determined for a second user identified as meeting the selected user's search parameters based on how well the second user's characteristics match or do not match the selected user's preferences. In one embodiment, a second user's preference score with respect to the selected user may be identified by comparing the profile characteristics received from the second user as registration information with the preference information provided by the searcher as registration information. Preference information received from the searcher (i.e. the selected user) as registration information and stored as part of step 210 may or may not be identical or similar to the search parameters received from the searcher. In one embodiment, a second user whose characteristics closely match the searcher's preferences may be assigned a higher preference score than another user that does not match the searcher's preferences as well. In one embodiment, the preference score for a second user may also reflect how well the searcher's characteristics match or do not match the second user's preference information, as described in the related application.

A compatibility score for a second user may be determined with respect to the selected user by identifying how similar the characteristics of the selected user are to other users with which the second user has had relationships, and identifying how similar the second user is to the other users with which the selected user has had relationships. In one embodiment, if the selected user's characteristics match characteristics associated with one or more other users with whom the second user has previously had a long relationship, then the second user may be assigned a higher compatibility score with respect to the selected user, and vice versa. If the selected user's characteristics match characteristics associated with one or more other users with whom the second user had a shorter relationship, then the second user may be assigned a lower compatibility score.

Each of the preferences and characteristics may be weighted when computing preference and compatibility scores. In determining preference scores and/or compatibility scores for any two users, any date and time information corresponding to updated preference information stored for each user may be retrieved, and weights corresponding to any preference information that was updated by a user shortly after a breakup indication was received from that same user may be updated to reflect such post-breakup updates. In one embodiment, the weights corresponding to preference information that is updated shortly after a breakup may be increased in determining preference scores. For example, if shortly after a breakup indication corresponding to a former pairing with a male user with a high level of interest in the outdoors, a female user Alice updates her preference for men with a high interest in the outdoors to a preference for men with a low level of interest in the outdoors and a high level of interest in movies and a high level of interest in food and wine, then the weights corresponding to the specified interest in the outdoors, interest in movies, and interest in food and wine may be increased to reflect Alice's updated preferences with respect to the preference score. In one embodiment, weights corresponding to preference information updated by a user more than a short period of time after a breakup indication may be adjusted as described above if little to no activity of any other kind has been recorded for such user on the website for which such user registered for a period after the date and time of the breakup indication but the preference information was changed within a threshold period of time (e.g. one month) following the resumption of activity on the web site.

Weights for determining the compatibility scores may be lowered for those preferences changed after a breakup indication is received so that one user is not considered less compatible with the other user even though characteristics of the other user's partner in their long term relationships are different from characteristics that were changed by such other user when the preference of the other user included the characteristics of the partner before the changes excluded the partner after the change.

A popularity score for a second user or any user may be determined based on the number and/or type of actions made by other users with respect to such second users, such as the number of clicks on the second user's summary profile relative to the number of times the second user's summary profile is displayed to any other user, the number of times the second user has been initially contacted by other users, the number of times that other users have responded to any initial contact initiated by the second user, or any other actions made with respect to the second user, as described in the related application. In one embodiment, if a high number of actions by other users is recorded with respect to a user, then such user may be assigned a higher popularity score than if fewer actions are recorded.

A relationship suitability score may be determined for a second user or any user based on the number and/or length of any previous relationships or couple pairings recorded for such user. In one embodiment, a user may be assigned a higher relationship suitability score if a higher number of pairings with other users have been recorded for the user or pairings of longer lengths of time have been recorded for the user than if fewer pairings with other users have been recorded or only pairings of shorter lengths of time have been recorded. In one embodiment, a user for which only a high number of short pairings with other users is recorded may be assigned a very low or negative relationship suitability score.

Sort Identified Other Users.

Other users identified as meeting the selected user's search parameters are sorted 314 with respect to the selected user using the match scores identified for each other user with respect to the selected user as part of step 312. The weights may be identified using conventional regression analysis techniques to maximize the number of clicks on a summary profile by a user who views such profile after a search. In one embodiment, the weight for the compatibility score may be lowered for the user who broke off the relationship or raised for the user who did in the event that both users responded consistently to the question of who broke off the relationship that is presented when a breakup indication is received. In the event that there are multiple broken up relationships, compatibility scores may be identified for each of the relationships, then the scores are weighted and combined, with more recent ones weighted higher than older ones, and those for which the user did not break off the relationship weighted higher than those for which the user broke off the relationship.

Record Display of Users.

For each other user whose summary profile is about to be displayed to the selected user as described below, the instance of being displayed as the result of a search is recorded 316 for such other user, along with the user identifier corresponding to the selected user to which the other user is displayed.

Display Summary Profile of Other Users in Sorted Order.

Information regarding the other users meeting the search term parameters are displayed in sorted order 318. In one embodiment, a summary profile is displayed for each of the other users meeting the search parameters, and the summary profiles are displayed such that the other users with the highest match scores are displayed first and the users with the lowest match scores are displayed last. In one embodiment, such other users may be displayed in groupings of any number, such as in groups of ten, in which case the summary profiles of ten other users is shown to the selected user at one time, in sorted order, and if the selected user wishes to see additional other users meeting the selected user's search parameters, the selected user may click a link or button to view the next ten (or any number) of other users meeting the search parameters and such other users are displayed.

Receive Action: Click or New Search.

When the summary profile(s) of other user(s) meeting the selected user's search parameters has been displayed in sorted order, an action may be received 320 from the selected user, such as a click on any summary profile displayed to the selected user or an indication to begin a new search.

If Action is New Search.

If the selected user's action is received as an indication to begin a new search 322, then the method continues at step 308.

If Action is Click.

Record Clicked Profile of Other User.

If the selected user's action is received as a click on the summary profile of a displayed other user 322, then the selected user's click is recorded 324 with the user identifier of clicked other user, along with the user identifier of the selected user from which the click is received. The other user's popularity score may be affected by the recorded click as described herein.

Display Complete Profile of Clicked Other User.

Complete profile information corresponding to the other user whose summary profile was clicked by the selected user is displayed 326 to the selected user.

Receive Action: Contact, Back or New Search.

Once the complete profile of the user corresponding to the received click has been displayed to the selected user, an action may be received 340 from the selected user, such as an indication to begin a new search, an indication to go back or return to the previously displayed search results, an indication to contact the other user whose complete profile information is displayed, or any other action. In one embodiment, the action may be received as a click on one of any number of links or buttons displayed with the complete profile information, including a link for a new search, a link to go back, a link to contact the displayed other user, and/or any other link.

If Action is Search.

If the selected user's action is received as an indication to begin a new search 342, the method continues at step 308.

If Action is Back.

If the selected user's action is received as an indication to return to the previously displayed search results 342, the method continues at step 318.

If Action is Contact.

Receive, Provide Message to User.

If the selected user's action is received as an indication to contact the other user corresponding to the complete profile currently displayed 342, then an initial contact message, such as an email, is received from the user, and the initial contact message is provided to the other user using conventional email and/or notification techniques 344.

Store Indication of Initial Message.

A record is stored 346 that such initial contact message has been sent from the selected user to the other user. Such record of the initial contact message may be used in determining the other user's popularity score as described below. In one embodiment, if the same selected user sends any additional messages to the same other user after the initial contact message, such additional messages may not be recorded. In one embodiment, once the selected user's initial contact message has been provided to the other user, the other user may respond to the selected user's message, such as by sending an initial response message.

If No Response.

If the other user does not respond to the selected user's initial contact message 348, then the method continues at step 318.

If No Minimum Length Response.

If the other user responds to the selected user's initial contact message, but the other user's initial response message does not meet a minimum length requirement 348, then the method continues at step 352.

If Minimum Length Response.

Store Indication Of Initial Response Of Minimum Length.

If the other user responds to the selected user's initial contact message, and the other user's initial response message meets a minimum length requirement 348, then a record of the initial response message meeting the minimum length requirement is stored 350 for the selected user, along with the user identifier of the other user from which the initial response message is received. Such record of the initial response message may be used to assign the selected user's popularity score as described herein.

Forward Response.

The other user's initial response message is forwarded 352 to the selected user.

Using the actions, including the number of actions and types of actions, recorded as described above for each user with respect to all other users, a popularity score may be determined for each of all users. Actions affecting a user's popularity score may include the number of clicks that the user receives on his/her summary profile from other users (recorded as part of step 324) relative to the number of times that the user is displayed as a search result to any other users (recorded as part of step 316), the number of times the user is contacted by any other users, such as via an initial contact message (recorded as part of step 346), and the number of responses that the user receives (recorded as part of step 350) in response to any initial contact messages sent by the user to other users.

In one embodiment, a user receiving a higher number of clicks on the user's summary profile compared to the number of times the user's summary profile is displayed to other users as a search result is assigned a higher popularity score than another user receiving a lower ratio of clicks on such other user's summary profile.

In one embodiment, a user that is initially contacted by a greater number of other users may be assigned a higher popularity score than a user that is not initially contacted by any other users or initially contacted by fewer other users. In one embodiment, a user that receives many responses meeting the minimum length requirement to initial contact messages sent by the user may be assigned a higher popularity score than another user that receives fewer responses meeting the minimum length requirement.

In one embodiment, being contacted by another user via an initial contact message may raise a user's popularity score more greatly than having the user's summary profile clicked on by another user. Receiving a response meeting the minimum length requirement may also increase a user's score more greatly than having the user's summary clicked on by another user.

Using Breakup Information to Match Users.

Select First User.

FIG. 3B is a flowchart illustrating a method for matching and connecting well-matched pairs of users according to one embodiment of the present invention. Referring now to FIG. 3B, a first user is selected 360 from the pool of all users.

Restrict Universe of Other Users.

Using profile characteristics and preference information corresponding to the selected user, the universe of all other users is optionally restricted 362. In one embodiment, the universe of other users may be restricted using any parameters, including gender, sexual orientation, location, and/or any other characteristics or preference information. To restrict the universe of other users based on gender and sexual orientation, other users not matching the selected user's gender preference may be removed from the restricted universe of other users. For example if the selected user is a heterosexual female, then the universe of other users may be restricted to include only heterosexual males. To restrict the universe of other users based on location, only other users within a threshold maximum distance from the location of the selected user may be included in the restricted universe for the selected user. In one embodiment, the threshold maximum distance may be a distance received from the selected user or it may be a default threshold distance, such as fifty miles. In one embodiment, the selected user's restricted universe of other users may also be restricted to exclude any other users that have been previously matched and/or connected with the selected user as described in more detail below.

Compute Match Score(s).

One or more match scores are computed 364 for each other user included in the selected user's restricted universe of other users. In one embodiment, the match scores are computed for each other user with respect to the selected user as described in more detail with respect to FIG. 3A.

More Users.

Select Next User.

If more users exist 366, the next user is selected 368 and the method continues at step 360 with the next selected user.

If No More Users.

Select First User.

When one or more match scores have been computed for every user with respect to every other user in that user's restricted universe 366, a first user is selected 370.

Select Best Match/Mutual Match Using Weighted Scores.

Using the match scores computed with respect to the selected user as described above with respect to FIG. 3A, a best match or best mutual match is selected for the selected user, and the selected user may be notified of the selected best match 372. In one embodiment, the best match for the selected user may be selected by multiplying each user's match scores by a corresponding weight, summing the results, and selecting the other user with the highest sum. The best mutual match for the selected user may be identified by computing the sum, described above, for each of the user and the other user and selecting the other user for which the total of the sum with respect to the other user, and the sum in the other direction for the selected user with respect to the other user, is higher than the total for any other user with the selected user, provided each such sum exceeds a minimum threshold. In one embodiment, the selected user may be notified of the selected best match using conventional notification techniques, such as email or other messages, and any notification to the selected user may include the profile or a summary profile of the selected best match and one or more links to view more information corresponding to the selected best match. If the selected best match is also a best mutual match, then the selected best mutual match is also notified of the selected user in a similar manner.

Optionally Remove Mutually Matched from Pool.

Optionally, the selected best match or mutual match may be removed 374 from the pool of other users from which to select subsequent best matches or best mutual matches for other selected users as described above. In one embodiment, if the selected best match is a best mutual match, then both the selected best match and the selected user may be removed from the pool of other users.

More Users.

Select Next User.

If more users exist for which to select a best match or best mutual match 376, the next user is selected 378, and the method continues at step 372 using the newly-selected user.

No More Users.

Wait.

If no more users exist for which to select a best match or best mutual match 376, then the method waits 380 for the next match selection period, and then the method continues at step 360 for the next match selection period.

It is noted that the searching and matching may also be affected by the procedures and system components described in the related application.

The user may use the search results or matches to arrange a meeting with one or more of the other users searched or matched and the two users will move themselves to the meeting place and may perform an activity together or use or consume products together at that place.

System.

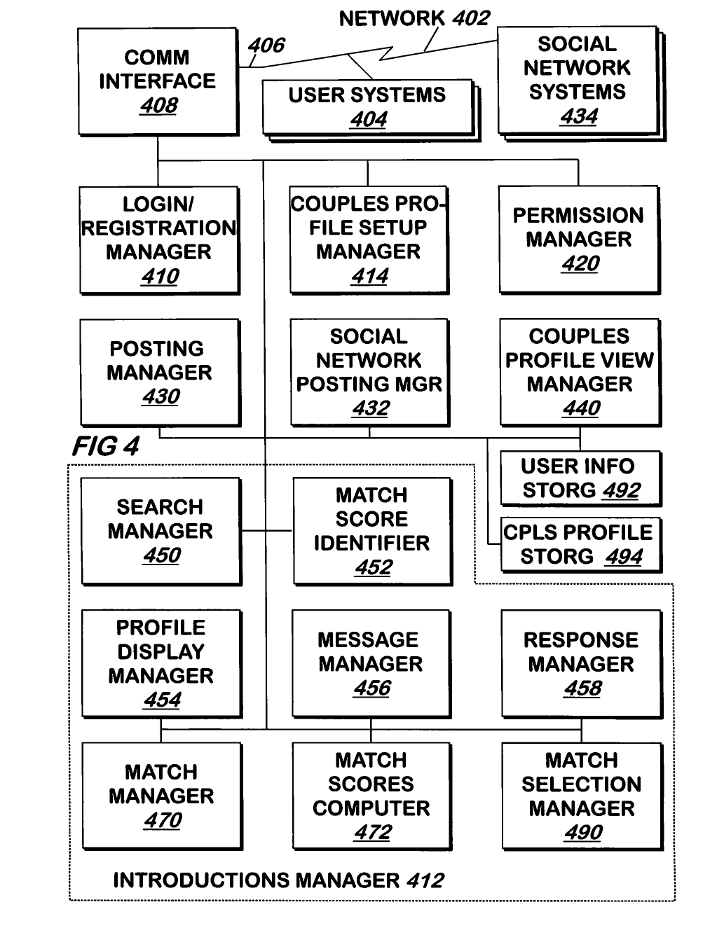

FIG. 4 is a block schematic diagram of a system for providing and receiving information to allow users and non users to view and interact with a couples profile according to one embodiment of the present invention. Referring now to FIG. 4, the system includes any number of user systems 404 and communication interface 408 which may include a conventional communication interface running suitable communication protocols, such as Ethernet, TCP/IP or both. In one embodiment, unless otherwise noted herein, users communicate with the system elements numbered 410 and above (which may reside on one or more conventional web servers) via network 402, which may include a conventional Ethernet network, the Internet, or both. All communications in and out of the server are made via input/output 406 of communication interface 408.

Any number of users using any number of user systems 404 may provide registration information and/or log in information as described above. Log in/registration manager 410 receives the registration information, including a user identifier and password, profile characteristics information and preference information as described above, and log in/registration manager 410 stores any such information in user information storage 492 associated with the user identifier corresponding to the user from which the information is received. All storage elements described herein such as user information storage 492 may include conventional memory and/or disk storage and may include a conventional database.

In one embodiment, when log in/registration manager 410 receives registration information and/or log in information from a user system 404, log in/registration manager 410 may store a cookie on the user system 404 including the received user identifier, or an encrypted user identifier, or a session serial number stored in association with the received user identifier in user information storage 492, or any other information which may be retrieved and used by other elements of the system described herein to identify the current user.

Introductions manager 412 connects pairs of users such as in the manner of a conventional dating website as described in the related application and above with respect to FIGS. 3A and 3B. To connect or introduce the pairs of users, introductions manager 412 uses profile and preference information corresponding to any number of users from user information storage 492 and couples profile storage 494 to allow users to search and/or select a best match or best mutual match for each user as described above, and introductions manager 412 stores a record of the actions of each of the pairs of users introduced as described herein with the date and time when the two users were introduced. As noted, couples may register already paired, in one embodiment.

At any time, couples profile setup manager 414 may receive a request from a user to build a couples profile as described above to indicate establishment of a relationship with another user as described above. In one embodiment, couples profile setup manager 414 receives the request to build the couples profile via a click on a link to request to a couples profile that specifies couples profile setup manager 414. Such link may be provided to any logged in user by log in/registration manager 410. In one embodiment, couples profile setup manager 414 receives the request to build the couples profile, retrieves from the cookie the user identifier corresponding to the user requesting the couples profile, and provides a user interface element to receive, and does receive, the user identifier corresponding to the second user to associated with the couples profile as described above, and couples profile setup manager 414 stores the requested couples profile in couples profile storage 494 along with the two user identifiers received and a unique couples profile serial number it issues. In one embodiment, couples profile setup manager 414 stores the couples profile in couples profile storage 494 marked as inactive. Any couples profile marked as inactive in couples setup manager 414 may not be available for viewing to any users except the user requesting to build the couples profile.

In one embodiment, couples profile setup manager 414 provides a suitable user interface to allow the user to provide any social network account identifiers and auto-posting options, as described above, and to import any social network friends, or indicate permission to import or access social network friends, and provide corresponding friends posting, messaging, viewing and other permissions as described above. The user may provide such information, which couples profile setup manager 414 receives and stores in couples profile storage 494 associated with the couples profile serial number and the user's user identifier. In one embodiment, couples profile setup manager 414 stores any received information corresponding to the couples profile in couples profile storage 494 associated with the date and time that such information is received.

In one embodiment, the user requesting to build the couples profile may provide posts containing information corresponding to the requested couples profile and such received information is stored in couples profile storage 494 associated with the couples profile serial number at any time as described in more detail below. However, no posting information or other activity corresponding to the couples profile may be viewed by any other users until permission to build the couples profile has been granted by the second user associated with the couples profile as described above and below.

Couples profile setup manager 414 stores a notification for the second user from which permission to build the couples profile is needed, such as by marking second user's user identifier in user information storage 492 with the serial number corresponding to the couples profiles requested.

The second user logs in any conventional manner, such as by providing the second user's previously established user identifier and corresponding password to log in/registration manager 410 via the suitable user interface elements log in/registration manager 410 provides. When log in/registration manager 410 receives the user identifier and corresponding password, log in/registration manager 410 checks for any notifications associated with the received user identifier in user information storage 492. If log in/registration manager 410 identifies a couples profile serial number notification associated with the received user identifier in user information storage 492, it notifies the second user of the request to build the couples profile associated with the second user's user identifier as described above, such as via a conventional notification message, and also provides the user identifier of the user requesting to build the couples profile with the second user and a response link or button specifying permission manager 420.

The second user receives the notification and clicks the response link provided, and permission manager 420 receives the click along with the second user's user identifier and the couples profile serial number, and permission manager 420 provides suitable user interface elements to allow the second user to provide an indication to grant permission or deny permission to build the requested couples profile, which the user provides, and permission manager 420 receives. If permission manager 420 receives an indication from the user to deny permission to build the couples profile, it may mark the request as denied in couples profile storage 494, or it may leave the inactive mark associated with the couples profile, or it may store any other indication that permission to build such couples profile is not received.

If permission manager 420 receives an indication to grant permission to build the requested couples profile, permission manager 420 identifies the couples profile associated with the received couples profile serial number in couples profile storage 494 and marks such couples profile as active, such as by storing an indication that the couples profile is active or by unmarking as inactive or removing the inactive mark associated with the couples profile serial number in couples profile storage 494. In one embodiment, permission manager 420 also marks the date and time when permission to build the profile was granted by the second user. Permission manager 420 signals couples profile setup manager 414 that such permission from the second user has been granted, and permission manager 420 may provide the couples profile serial number and/or the second user's user identifier to couples profile setup manager 414.

Couples profile setup manager 414 receives the signal and serial number from permission manager 420, and couples profile setup manager 414 provides a suitable user interface to allow the second user to provide social network account identifiers, auto-posting permissions, social network friends and friends viewing and posting permissions information in a manner similar to the manner in which it provided the user interface to the first user above. The user provides such information, which couples profile setup manager 414 receives and stores in couples profile storage 494 associated with the couples profile serial number, the second user's user identifier and the date and time that such information is received.

When the couples profile has been built and approved as described above, log in/registration manager 410 creates a link to the couples profile, and REST information included in the link may include the assigned couples profile serial number. REST information is information to the right of the slash after the top domain name in a URL.

In one embodiment, log in/registration manager 410 provides the link or URL to the couples profile, including the REST information, to the user via the user's couples profile or any other manner.

When a user is logged in, log in/registration manager 410 provides a suitable user interface to allow the user to make any number of actions with respect to a couples profile if the couples profile serial number is associated with the user's user identifier in couples profile storage 494. Such actions include providing a breakup indication corresponding to the couples profile or making a post to the couples profile or commenting on a post to the couples profile.

When a logged in user provides an action with respect to a couples profile associated with the logged in user, posting manager 430 receives any such action from the user and stores the received action in couples profile storage 494 associated with the user identifier corresponding to the logged in user, the couples profile serial number corresponding to the logged in user, a posting serial number, and the date and time that such action is received. Based on the action or type of action received, posting manager 430 also performs other actions corresponding to the received action as described below.

If posting manager 430 receives an indication to enable breakup corresponding to a couples profile, such as if a logged in user presses or clicks an enable breakup button or link provided by log in/registration manager 410, posting manager 430, posting manager 430 marks the couples profile associated with the received breakup indication as inactive due to a breakup and stores the current date and time in couples profile storage 494.

Posting manager 430 may also provide a suitable user interface to request and receive breakup information from the user, such as which user corresponding to the couples profile is the initiator of the breakup as described above. Posting manager 430 stores any breakup information received in couples profile storage 494 associated with the posting serial number corresponding to the received breakup indication. In one embodiment, posting manager 430 identifies the second user associated with the couples profile for which the breakup indication is received, and posting manager 430 stores a breakup notification for such identified user in user information storage 492 associated with the identified user identifier. Breakup information may subsequently be requested and received from the second user corresponding to the couples profile in a manner similar to the manner in which permission to build a requested couples profile is requested and received above.

If posting manager 430 receives an indication to disable an enabled breakup corresponding to the couples profile, such as if the logged in user presses or clicks a disable breakup or reunite button or link provided by log in/registration manager 410, posting manager 430 may unmark the couples profile as inactive (or otherwise store an indication that the profile is now active) in couples profile storage 494. In one embodiment, posting manager 430 may mark the couples profile as active when the reunification indication is received, or posting manager 430 may mark it as active when confirmation is requested and received from the second user corresponding to the couples profile in a manner similar to that described above.

If posting manager 430 receives post information, such as if the user provides text information, photo information, link information, comment and/or indication of approval information via a suitable user interface provided by log in/registration manager 410 and clicks a post or submit button provided by log in/registration manager 410, posting manager 430 issues a unique the posting serial number to the post and stores the post and posting serial number associated with the couples profile serial number and user identifier corresponding to the user from which the post information is received and provides the posting serial number to social network posting manager 432.

Social network posting manager 432 receives the posting serial number and social network posting manager 432 checks the auto-posting options associated with the user identifier in couples profile storage 494 corresponding to the posting serial number, and reposts the post information corresponding to the posting serial number to any number of social network systems 434 using the user's social network account identifiers as described above and in more detail below. In one embodiment, social network posting manager 432 retrieves any social network account identifiers and permissions information from couples profile storage 494, and social network posting manager 432 posts information to any social network system 434 along with the link or URL corresponding to the couples profile, including the couples profile serial number in the REST information corresponding to the link as described above.

A user may request to view a couples profile at any time. In one embodiment, the user may request to view the couples profile by clicking on the link or URL specifying the couples profile, which may be provided on any number of social networks, or provided by log in/registration manager 410 as described above, or provided to users in any other manner. When the user clicks the link, couples profile view manager 440 receives a request, including the REST information included with the link that includes the profile serial number, and couples profile view manager 440 provides to user system 404 for display the requested couples profile corresponding to the serial number along with any postings or comments on postings stored in association with the couples profile in couples profile storage 494. In one embodiment, couples profile view manager 440 provides for display the couples profile and posts and also provides for display one or more buttons or links to allow the viewer to indicate approval of the couples profile or indicate approval of individual posts made to the couples profile, such as one or more “thumbs up” buttons corresponding to the couple or to specific posts.

In one embodiment, couples profile view manager 440 may store a counter for each “thumbs up” button displayed in couples profile storage 494 associated with the couples profile serial number and posting serial number corresponding to the post for which the “thumbs up” button is displayed. If the user clicks any “thumbs up” button displayed, couples profile view manager 440 receives the click with the corresponding couples profile serial number and posting serial number and increments a “thumbs up” counter corresponding to the couples profile serial number and posting serial number and stores the date and time when the click on the “thumbs up” button is received and the user identifier of the user from which the click is received. Couples profile view manager 440 may display each “thumbs up” counter along with the button corresponding to such counter. In one embodiment, couples profile view manager 440 may also increment and display a counter for indications of approval received with respect to the couple associated with the couples profile, stored associated with the couples profile serial number in couples profile storage 494.

In one embodiment, couples profile view manager 440 identifies the user viewing the couples profile, such as by attempting to retrieve a cookie previously stored on the user's device by log in/registration manager 410. If couples profile view manager 440 does not retrieve a cookie but identifies the request to view the couples profile as a request received via a social networking website such as via REST information provided by social network posting manager 432, and if at least one of the users corresponding to the couples profile has given permission for social network friends to post and/or comment as stored in couples profile storage 494, then couples profile view manager 440 sends a request to social network system 434 from which the request was received to identify the social network user viewing the couples profile and receives the response. In one embodiment, if the user is logged in to the social networking website (or logs in after prompting), social network system 434 provides the user's social network account identifier in response. Couples profile view manager 440 receives any such response.

If permission to import or otherwise access social network friends associated with the requested couples profile has been received and stored in couples profile storage 494, couples profile view manager 440 may also send a request to social network system 434 for social network friends information corresponding to any number of social network account identifiers associated with the requested couples profile in couples profile storage 494. If any response is provided by social network account 434, couples profile view manager 440 receives it.

Using the friends posting and messaging permissions in couples profile storage 494 corresponding to the requested couples profile, and if any social network account identifier received from social network system 434 is identified as a social network friend associated with the couples profile and identified as having been granted friends posting or messaging permissions, then couples profile view manager 440 displays suitable user interface elements to allow the viewing user to provide post or comments information and post to the couples profile or comment on any posts to the couples profile or send messages to one or both of the couple as described above. The user may provide such posting or comments, and couples profile view manager 440 receives and stores the information in couples profile storage 494 associated with the couples profile serial number, a post serial number, and an identifier of the social network friend from which the post or comment information is received, such as the friend's social network account identifier. Such information is provided for display to that viewer and subsequent viewers of the couples profile. In the case of a message, couples view profile manager provides the contents of the message to message manager 456, an indication of the user or users of the couples profile to which the message should be sent in accordance with the friend posting and messaging permissions of the couple, and the user identifier (i.e. the name) of the friend from the social network, and message manager 456 sends the message to the user or users from the friend as described herein.

In one embodiment, couples profile view manager 440 only allows persons other than the couple itself to view the couples profile if the party requesting to view the couples profile is a friend of at least one of the two users in the couple on any social network account specified by the users in the couple as described above if the permissions stored in couples profile storage 494 so specify. Couples profile view manager 440 reads the permissions corresponding to the requested couples profile, and if viewing is limited to friends couples profile view manager requests from social network system 434 the friends list of the couple and the user identifier of the person from which the request was received. Couples profile view manager compares the user identifier to determine if the viewing user is a friend of either of the couple and only operates as described herein if the person is such a user, unless a cookie is read indicating that the person requesting to view the couples profile is one of the two users in the couple. Couples profile view manager 440 may provide a user interface that allows persons not logged into a social network account to authenticate themselves to the social network system 434 and then grant the permissions that apply to that user. Couples profile view manager may provide user interfaces to any number of social network systems 434.

In one embodiment, if couples profile view manager 440 retrieves a cookie from the user system 404 requesting to view the couples profile and matches the user identifier included in such cookie with a user identifier associated with the requested couples profile in couples profile storage 494, or otherwise identifies the viewer of the couples profile as one of the two users associated with the couples profile, then couples profile view manager 440 displays the user interface elements specifying posting manager 430 described above that allow the user associated with the couples profile to post or comment on posts to the couples profile as described above.

Additionally, couples profile display manager 440 retrieves any auto-posting permissions associated with the requested couples profile serial number and the user identifier included in the cookie in couples profile storage 494. If couples profile display manager 440 determines that auto-posting permissions to the viewing user's social network account have not been previously granted and stored in couples profile storage 494, then couples profile display manager 440 may also display a manual repost button to allow the viewing user to manually indicate permission to repost a post on the couples profile to the user's social network account as described above. If the user clicks the manual repost button, couples profile display manager 440 receives the click along with the posting serial number, and couples profile display manager 440 provides the posting serial number and couples profile serial number to social network posting manager 432 along with an indication that manual posting permission is received from the user, and social network posting manager 432 receives the posting information and reposts the posting information to the user's social network account in a manner similar to the manner in which it auto-posts to the user's social network as described above.

In one embodiment, when a user logs in using login/registration manager 410, login/registration manager 410 provides a link to perform a search. If the user clicks the link, search manager 450 is signaled, and retrieves the cookie containing the user's user identifier from user system 404 that login/registration manager 410 ads when the user successfully logs in.

When signaled, search manager 450 provides the user a user interface to provide the search parameters, and receives such search parameters and performs the search using the parameters and the information stored in user information storage 492 and optionally couples profile storage 494. In one embodiment, search parameters may include information stored in couples profile storage 494, such as whether a user has been in a long-term relationship, the number of such relationships, and characteristics of the users partners in such long-term relationships. Search manager 450 issues a unique serial number for the search, and stores this serial number associated with the identifiers of the users meeting the search parameters in user information storage 492. Search manager 450 then provides the search serial number and the user identifier of the user who requested the search to match score identifier 452. Match score identifier 452 identifies the match score as described above for each user corresponding to the search identifier it receives using their user information in user information storage 492, any couples profile information in couples profile storage 494 and similar information of the user whose user identifier is received as described above. Match score identifier 452 stores in user information storage 492 the match scores associated with the user identifier of each user corresponding to the serial number of the search and signals search manager 450 with the serial number of the search. Search manager 450 uses the serial number of the search and the match scores stored in user information storage 492 to sort the users with the search identifier, corresponding to their match scores in descending order of the scores, and provides for display to the user system 404 of the user requesting the search, summary profiles of sets of the users as described above in descending order of their match scores.

As search manager 450 provides for display the summary profiles, it records such display in user information storage 492, for example by incrementing a counter corresponding to the users whose summary profiles are displayed. The summary profiles are provided in a manner that allows a user to click on the summary profile, along with a user interface control for the user to request a new search. If the user requests a new search, search manager 450 again provides the user interface to receive search parameters as described above, and the process may be repeated any number of times. If the user clicks on a summary profile, profile display manager 454 is signaled with an identifier of the user on whose summary profile was clicked.

When it receives the user identifier, profile display manager 454 provides for display to user system 404 of the user who clicked on the summary profile the complete profile of the user corresponding to the identifier receives, along with user interface controls allowing the user viewing such profile to allow the user to see the last page of search results, to contact the user corresponding to the profile, or to perform a new search. If the user selects the user interface control to perform a new search, profile display manager 454 signals search manager 450, which repeats the process as described above. If the user clicks the user interface control to see the prior page of search results, the user will cause their browser to perform a back command and the browser will display such search results. If the user clicks on the user interface control to contact the user corresponding to the profile, profile display manager 454 signals message manager 456 with the identifier of the user being contacted, and the manner of contact the user requested, such as via an e-mail type message or and IM type message.

When message manager 456 receives such information and reads the user identifier from the cookie, it provides to user system 404 a user interface allowing the user to compose a message in the manner requested, receives the message and sends it to the user indicated as described above by storing it in user information storage 492 associated with the recipient of the message and the sender of the message. If the message is a sufficient length, which may be any length greater than zero, message manager 456 stores in user information storage 492 an indication that the recipient of the message was sent a message. When such recipient logs in using login/registration manager 410, login/registration manager 410 checks user information storage 492 for any messages that are unread, and indicates to the user via a link that the message is available. If the user clicks the link, message manager 456 is signaled and, using the user identifier on the user's cookie, displays read and unread message headers and allows the user to read messages using conventional techniques. When message manager 456 displays a message, it displays a user interface control allowing the recipient of the message to reply to the message, and provides user interface to allow the user to supply a reply, and if the user provides a reply and presses a send button, response manager 458 receives the reply Response manager 458 stores the reply in a manner similar to that of the original message, but for the recipient of the reply. If the user is replying to the sender of the message for the first time, response manager 458 stores an indication of the response, including the recipient of the response and the date and time, in user information storage 492 if the responses is of a sufficient length.

Periodically, match manager 470 may match users as described above. In one embodiment, to match users, match manager 470 selects a first user, issues a unique serial number to the match for the selected user, stores the serial number associated with the selected user in user information storage 492, and provides the match serial number to match scores computer 472. When it receives the serial number, match scores computer 472 identifies the other users in the restricted universe for the user corresponding to the serial number at receives as described above, and computes match scores for each of such other users with respect to the user, and optionally vice versa, as described above, using the information in user information storage 492, and couples profile storage 494. Match scores computer 472 stores in user information storage 492 the match scores associated with the match serial number and the user identifier of the other user to which the match score corresponds, and signals match manager 470. If there are more users that have not been selected, match manager 470 selects the next user, and repeats the process described above for the newly selected user. If there are no more users that have not been selected, match manager 470 provides the match serial number of the first selected user to match selection manager 490. Match selection manager matches the users as described above with respect to steps 370 through 378 of FIG. 2C and stores indications of the matched users in user information storage 492. When users log in via login/registration manager 410, login/registration manager 410 provides a user interface control such as a link to allow the user to view summary profiles for the users matched to that user as stored in user information storage 492. If the user clicks the link or other user interface control, login/registration manager 410 signals search manager 450, which displays summary profile information for each of the matched users and allows interaction with such summary profiles as described above. Actions of the users may be recorded in the manner described above. Match manager 490 waits until the next period, and repeats the process described above.

In one embodiment, elements 450-490 are part of introductions manager 412, though introductions manager 412 may also perform other functions conventionally used to introduce users to one another and to facilitate communications among them to facilitate matching of users.

Features.

A method of distributing information about a first user and a second user across a network of computers is described including receiving over the network information about the first user and the second user at a computer system that introduced the first and second users to one another; receiving over the network a first indication from the first user that the first user and the second user have established a relationship; confirming with the second user via the network at least that that the first user and the second user have established a relationship; and responsive to the first indication received and the confirming step, distributing over the network to two or more computer systems coupled to the network the information about the first user and the second user on a web page corresponding to the first user and the second user.

The method may additionally include receiving via the network a second indication from the first user or the second user that the first user and the second user are no longer in a relationship; and inhibiting a display of the information about the first user and the second user on the web page.

The method may additionally include receiving over the network a third indication that the relationship between the first user and the second user has been resumed after receiving the second indication from the first user or the second user that the first user and the second user are no longer in a relationship; and responsive to the third indication received, distributing over the network to computer systems coupled to the network at least some of the information about the first user and the second user on the web page corresponding to the first user and the second user that had been distributed responsive to the first indication received.

The method may additionally include receiving from at least some of the computer systems coupled to the network two or more approvals of the relationship from entities other than the first user and the second user; and may include a feature whereby the web page is distributed responsive to the two or more approvals.

The method may include a feature whereby the distributing over the network is performed by posting the information to at least one social network account of at least one selected from a group including the first user and the second user.

The method may additionally include receiving additional information about the first user and the second user; and automatically, without user input, posting the additional information to the at least one social network account of the group.

A system for distributing information about a first user and a second user across a network of computers is shown, including a login/registration manager having an input for receiving over the network information about the first user and the second user, the login/registration manager for providing at an output the information about the first user and the second user; a couples profile setup manager having an input for receiving over the network a first indication from the first user that the first user and the second user have established a relationship, for receiving the identifier of the first user, and receiving the identifier of the second user, the couples profile setup manager for providing at an output the identifiers of the first user and the second user; a permission manager having an input coupled to the couples profile setup manager for receiving the identifiers of the first user and the second user, the permission manager for confirming with the second user via an input/output at least that the first user and the second user have established a relationship, and for providing at an output an output indication that the first and second user responsive to the second user confirming that the first user and second user have established a relationship; and a couples profile view manager having an input coupled to the login registration manager for receiving the information about the first user and the second user and to the permission manager for receiving the output indication, the couples profile view manager for, responsive to the output indication, distributing over the network to two or more computer systems coupled to the network the information about the first user and the second user on a web page corresponding to the first user and the second user.

The system may additionally include a posting manager having an input for receiving via the network a second indication from the first user or the second user that the first user and the second user are no longer in a relationship, the posting manager for providing at an output a breakup indication responsive to the second indication received at the posting manager input; and may include a feature whereby the couples profile view manager input additionally coupled to the posting manager output for receiving the breakup indication, the couples profile view manager additionally for inhibiting a display of the information about the first user and the second user on the web page.

The system may include a feature whereby the posting manager input is additionally for receiving over the network a third indication that the relationship between the first user and the second user has been resumed after receiving the second indication from the first user or the second user that the first user and the second user are no longer in a relationship, the posting manager for providing a resumption indication at the posting manager output responsive to the third indication received at the posting manger input; and the couples profile view manager input is additionally for receiving the resumption indication, and the couples profile view manager is additionally form responsive to the resumption indication received at the couples profile manager input, distributing over the network to computer systems coupled to the network at least some of the information about the first user and the second user on the web page corresponding to the first user and the second user that had been distributed responsive to the first indication received.

The system may include a feature whereby the couples profile view manager input is additionally for receiving from at least some of the computer systems coupled to the network two or more approvals of the relationship from entities other than the first user and the second user, and the couples profile view manager distributes the information on the web page responsive to the two or more approvals.

The system may additionally include a social network posting manager having an input for receiving the information about the first user and the second user, the social network posting manager for posting via an output at least some of the information received at the social network posting manager input to at least one social network account of at least one selected from a group including the first user and the second user.

The system may additionally include a feature whereby the social network posting manager input is additionally for receiving additional information about the first user and the second user; and the social network posting manager is additionally for automatically, without user input, posting via the social network posting manager output the additional information to the at least one social network account of the group.

A computer program product including a computer useable medium having computer readable program code embodied therein for distributing information about a first user and a second user across a network of computers is shown, the computer program product including computer readable program code devices configured to cause a computer system to: receive over the network information about the first user and the second user at a computer system that introduced the first and second users to one another; receive over the network a first indication from the first user that the first user and the second user have established a relationship; confirm with the second user via the network at least that that the first user and the second user have established a relationship; and responsive to the first indication received and the confirming step, distribute over the network to two or more computer systems coupled to the network the information about the first user and the second user on a web page corresponding to the first user and the second user.

The computer program product may, additionally including computer readable program code devices configured to cause the computer system to receive via the network a second indication from the first user or the second user that the first user and the second user are no longer in a relationship; and inhibit a display of the information about the first user and the second user on the web page.

The computer program product may additionally include computer readable program code devices configured to cause the computer system to receive over the network a third indication that the relationship between the first user and the second user has been resumed after receiving the second indication from the first user or the second user that the first user and the second user are no longer in a relationship; and responsive to the third indication received, distribute over the network to computer systems coupled to the network at least some of the information about the first user and the second user on the web page corresponding to the first user and the second user that had been distributed responsive to the first indication received.

The computer program product may additionally include computer readable program code devices configured to cause the computer system to receive from at least some of the computer systems coupled to the network two or more approvals of the relationship from entities other than the first user and the second user; and the web page is distributed responsive to the two or more approvals.

The computer program product may additionally include a feature whereby the computer readable program code devices configured to cause the computer system to distribute over the network comprises computer readable program code devices configured to cause the computer system to post the information to at least one social network account of at least one selected from a group including the first user and the second user.

The computer program product may additionally include computer readable program code devices configured to cause the computer system to receive additional information about the first user and the second user; and automatically, without user input, post the additional information to the at least one social network account of the group.

A method of displaying information about two or more users received from two or more computer systems over a network is described, including receiving information about characteristics and preferences of each of the two or more users including a first user, a second user and two or more additional users at a computer system having a network interface coupled to a network from the two or more computer systems coupled to the network; receiving a first indication that the first user and the second user are in a relationship; receiving a second indication that the first user and the second user have terminated the relationship corresponding to the first indication; and after the second indication is received, identifying at least one of the additional users in the plurality to the first user responsive to the information about at least some of the first users in the plurality; at least some of the information about the second user; at least some of the information about the first user; and the second indication.

The method may additionally include receiving an identifier of the first user or the second user as a user responsible for terminating the relationship; and may additionally include a feature whereby the at least one of the additional user in the plurality is identified additionally responsive to the identifier of the user responsible for terminating the relationship.

The method may additionally include a feature whereby the identifier of the user responsible for confirming the relationship is consistently received from both the first and second user.

The method may additionally include a feature whereby the at least one of the additional user in the plurality is identified additionally responsive to a comparison of at least some of the characteristics or preferences of the at least one additional user to those of the second user.

The method may additionally include a feature whereby, responsive to the user identifier of the second user having been received as the user responsible for terminating the relationship, the at least one of the additional user in the plurality is identified additionally responsive to a similarity of at least some of the characteristics or preferences of the at least one additional user to those of the second user.

The method may additionally include a feature whereby, responsive to the user identifier of the first user having been received as the user responsible for terminating the relationship, the at least one of the additional user in the plurality is identified additionally responsive to a dissimilarity of at least some of the characteristics or preferences of the at least one additional user to those of the second user.

A system for displaying information about two or more users received from two or more computer systems over a network is described, the system including a login/registration manager having an input for receiving information about characteristics and preferences of each of the two or more users including a first user, a second user and two or more additional users at a computer system having a network interface coupled to a network from the two or more computer systems coupled to the network, the login/registration manager for providing the information at an output; a setup manager having an input for receiving a first indication that the first user and the second user are in a relationship, the setup manager for providing at an output a relationship indication identifying the first user and the second user responsive to the first indication; a posting manager having an input for receiving a second indication that the first user and the second user have terminated the relationship corresponding to the first indication, the posting manager for providing at an output a termination indication responsive to the second indication; and an introductions manager having an input coupled to the login/registration manager for receiving the information, to the posting manager for receiving the termination indication, the introductions manager for identifying at an output at least one of the additional users in the plurality to the first user responsive to the information about at least some of the first users in the plurality, at least some of the information about the second user; at least some of the information about the first user; and the termination indication, received at the introductions manager input.

The system may additionally include a feature whereby the posting manager input is additionally for receiving an identifier of the first user or the second user as a user responsible for terminating the relationship and providing at the posting manager output the identifier of said user responsible for terminating said relationship; and the introductions manager input is additionally for receiving said identifier of said user responsible for terminating the relationship, and the introductions manager identifies the at least one of the additional user in the plurality additionally responsive to the identifier of the user responsible for terminating the relationship.

The system may additionally include a feature whereby the identifier of the user responsible for confirming the relationship is consistently received from both the first and second user by the posting manager.

The system may additionally include a feature whereby the at least one of the additional user in the plurality is identified by the relationship manager additionally responsive to a comparison of at least some of the characteristics or preferences of the at least one additional user to those of the second user.

The system may additionally include a feature whereby, responsive to the user identifier of the second user having been received as the user responsible for terminating the relationship, the relationship manager identifies the at least one of the additional user in the plurality additionally responsive to a similarity of at least some of the characteristics or preferences of the at least one additional user to those of the second user.

The system may additionally include a feature whereby, responsive to the user identifier of the first user having been received as the user responsible for terminating the relationship, the relationship manager identifies at least one of the additional user in the plurality additionally responsive to a dissimilarity of at least some of the characteristics or preferences of the at least one additional user to those of the second user.

A computer program product including a computer useable medium having computer readable program code embodied therein for displaying information about two or more users received from two or more computer systems over a network is described, the computer program product including computer readable program code devices configured to cause a computer system to receive information about characteristics and preferences of each of the two or more users including a first user, a second user and two or more additional users at a computer system having a network interface coupled to a network from the two or more computer systems coupled to the network; receive a first indication that the first user and the second user are in a relationship; receive a second indication that the first user and the second user have terminated the relationship corresponding to the first indication; and after the second indication is received, identify at least one of the additional users in the plurality to the first user responsive to the information about at least some of the first users in the plurality, at least some of the information about the second user; at least some of the information about the first user; and the second indication.

The computer program product may additionally include computer readable program code devices configured to cause the computer system to receive an identifier of the first user or the second user as a user responsible for terminating the relationship; and additionally include a feature whereby the at least one of the additional user in the plurality is identified additionally responsive to the identifier of the user responsible for terminating the relationship.

The computer program product may additionally include a feature whereby the identifier of the user responsible for confirming the relationship is consistently received from both the first and second user.

The computer program product may additionally include a feature whereby the at least one of the additional user in the plurality is identified additionally responsive to a comparison of at least some of the characteristics or preferences of the at least one additional user to those of the second user.

The computer program product may additionally include a feature whereby, responsive to the user identifier of the second user having been received as the user responsible for terminating the relationship, the at least one of the additional user in the plurality is identified additionally responsive to a similarity of at least some of the characteristics or preferences of the at least one additional user to those of the second user.

The computer program product may additionally include a feature whereby, responsive to the user identifier of the first user having been received as the user responsible for terminating the relationship, the at least one of the additional user in the plurality is identified additionally responsive to a dissimilarity of at least some of the characteristics or preferences of the at least one additional user to those of the second user.

What is claimed is:

1. A method of distributing information about a first user and a second user across a network of computers, comprising:
receiving over the network information about the first user and the second user at a computer system that introduced the first and second users to one another;
receiving over the network a first indication from the first user that the first user and the second user have established a relationship;
confirming with the second user via the network at least that that the first user and the second user have established a relationship; and
responsive to the first indication received and the confirming step, distributing over the network to a plurality of computer systems coupled to the network the information about the first user and the second user on a web page corresponding to the first user and the second user.

2. The method of claim 1, additionally comprising:
receiving via the network a second indication from the first user or the second user that the first user and the second user are no longer in a relationship; and
inhibiting a display of the information about the first user and the second user on the web page.

3. The method of claim 2, additionally comprising:
receiving over the network a third indication that the relationship between the first user and the second user has been resumed after receiving the second indication from the first user or the second user that the first user and the second user are no longer in a relationship; and
responsive to the third indication received, distributing over the network to computer systems coupled to the network at least some of the information about the first user and the second user on the web page corresponding to the first user and the second user that had been distributed responsive to the first indication received.

4. The method of claim 1:
additionally comprising receiving from at least some of the computer systems coupled to the network a plurality of approvals of the relationship from entities other than the first user and the second user; and
wherein the web page is distributed responsive to the plurality of approvals.

5. The method of claim 1, wherein the distributing over the network is performed by posting the information to at least one social network account of at least one selected from a group comprising the first user and the second user.

6. The method of claim 5, additionally comprising:
receiving additional information about the first user and the second user; and
automatically, without user input, posting the additional information to the at least one social network account of the group.

7. A system for distributing information about a first user and a second user across a network of computers, comprising:
a login/registration manager having an input for receiving over the network information about the first user and the second user, the login/registration manager for providing at an output the information about the first user and the second user;
a couples profile setup manager having an input for receiving over the network a first indication from the first user that the first user and the second user have established a relationship, for receiving the identifier of the first user, and receiving the identifier of the second user, the couples profile setup manager for providing at an output the identifiers of the first user and the second user;
a permission manager having an input coupled to the couples profile setup manager for receiving the identifiers of the first user and the second user, the permission manager for confirming with the second user via an input/output at least that the first user and the second user have established a relationship, and for providing at an output an output indication that the first and second user responsive to the second user confirming that the first user and second user have established a relationship; and
a couples profile view manager having an input coupled to the login registration manager for receiving the information about the first user and the second user and to the permission manager for receiving the output indication, the couples profile view manager for, responsive to the output indication, distributing over the network to a plurality of computer systems coupled to the network the information about the first user and the second user on a web page corresponding to the first user and the second user.

8. The system of claim 7:
additionally comprising a posting manager having an input for receiving via the network a second indication from the first user or the second user that the first user and the second user are no longer in a relationship, the posting manager for providing at an output a breakup indication responsive to the second indication received at the posting manager input; and
wherein the couples profile view manager input additionally coupled to the posting manager output for receiving the breakup indication, the couples profile view manager additionally for inhibiting a display of the information about the first user and the second user on the web page.

9. The system of claim 8, wherein:
the posting manager input is additionally for receiving over the network a third indication that the relationship between the first user and the second user has been resumed after receiving the second indication from the first user or the second user that the first user and the second user are no longer in a relationship, the posting manager for providing a resumption indication at the posting manager output responsive to the third indication received at the posting manger input; and
the couples profile view manager input is additionally for receiving the resumption indication, and the couples profile view manager is additionally form responsive to the resumption indication received at the couples profile manager input, distributing over the network to computer systems coupled to the network at least some of the information about the first user and the second user on the web page corresponding to the first user and the second user that had been distributed responsive to the first indication received.

10. The system of claim 7, wherein:
the couples profile view manager input is additionally for receiving from at least some of the computer systems coupled to the network a plurality of approvals of the relationship from entities other than the first user and the second user, and the couples profile view manager distributes the information on the web page responsive to the plurality of approvals.

11. The system of claim 7, additionally comprising a social network posting manager having an input for receiving the information about the first user and the second user, the social network posting manager for posting via an output at least some of the information received at the social network posting manager input to at least one social network account of at least one selected from a group comprising the first user and the second user.

12. The system of claim 11, wherein the social network posting manager input is additionally for receiving additional information about the first user and the second user; and the social network posting manager is additionally for automatically, without user input, posting via the social network posting manager output the additional information to the at least one social network account of the group.

13. A computer program product comprising a computer useable medium having computer readable program code embodied therein for distributing information about a first user and a second user across a network of computers, the computer program product comprising computer readable program code devices configured to cause a computer system to:
receive over the network information about the first user and the second user at a computer system that introduced the first and second users to one another;
receive over the network a first indication from the first user that the first user and the second user have established a relationship;
confirm with the second user via the network at least that that the first user and the second user have established a relationship; and
responsive to the first indication received and the confirming step, distribute over the network to a plurality of computer systems coupled to the network the information about the first user and the second user on a web page corresponding to the first user and the second user.

14. The computer program product of claim 13, additionally comprising computer readable program code devices configured to cause the computer system to:
receive via the network a second indication from the first user or the second user that the first user and the second user are no longer in a relationship; and
inhibit a display of the information about the first user and the second user on the web page.

15. The computer program product of claim 14, additionally comprising computer readable program code devices configured to cause the computer system to:
receive over the network a third indication that the relationship between the first user and the second user has been resumed after receiving the second indication from the first user or the second user that the first user and the second user are no longer in a relationship; and
responsive to the third indication received, distribute over the network to computer systems coupled to the network at least some of the information about the first user and the second user on the web page corresponding to the first user and the second user that had been distributed responsive to the first indication received.

16. The computer program product of claim 13, additionally comprising computer readable program code devices configured to cause the computer system to:
receive from at least some of the computer systems coupled to the network a plurality of approvals of the relationship from entities other than the first user and the second user; and
the web page is distributed responsive to the plurality of approvals.

17. The computer program product of claim 13, wherein the computer readable program code devices configured to cause the computer system to distribute over the network comprises computer readable program code devices configured to cause the computer system to post the information to at least one social network account of at least one selected from a group comprising the first user and the second user.

18. The computer program product of claim 17, additionally comprising computer readable program code devices configured to cause the computer system to:
receive additional information about the first user and the second user; and
automatically, without user input, post the additional information to the at least one social network account of the group.
